(19) United States
(12) Patent Application Publication
(10) Pub. No.: US 2009/0031869 A1
(43) Pub. Date: Feb. 5, 2009

(54) HAND TOOL BEING CONNECTED FIRMLY

(76) Inventor: Shusen Luo, Mazhuang Town (CN)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/815,551

(22) PCT Filed: Jan. 26, 2006
(86) PCT No.: PCT/CN06/00166

§ 371 Date: Apr. 11, 2008

(30) Foreign Application Priority Data
Feb. 5, 2005 (CN) 200520000408.5

(51) Int. Cl. B25G 3/28; B25G 3/14

(52) U.S. Cl. 81/489; 81/492

(57) ABSTRACT

This invention relates to an ax or hammer with firm connection including an ax or hammer head (1) and a grip (2). The ax or hammer head (1) has a fitting hole (11), the grip (2) has a fitting end (21). Characterized in that the outer surface of the fitting end (21) of said grip (2) has a longitudinal flute (23), the surface of the fitting hole (11) of the ax or hammer head (1) has a longitudinal convex arris (24), and after the fitting end (21) of the grip (2) is fitted into the mounting hole (11) of the body of the ax or hammer, the convex arris (24) is embedded into the flute (23). The ax or hammer with firm connection according to this invention has advantages of simple fitting process, firm fitting and high security in use.

### TECHNICAL FIELD

This invention relates to a hand tool, especially relates to a hand tool with firm connection.

### BACKGROUND ART

With regard to the hand tool used at present, the fitting end of the grip as well as its mounting hole generally adopts various cross sectional shapes, such as circle-and-quadrate shape or ellipse, etc. Although the grip and mounting hole with these cross sectional shapes have the advantages of simple manufacture and low production cost, the grip with such fitting structure is apt to volume constriction under the affection of some factors such as climate, environment, temperature and humidity, and when such constriction arrives at certain degree, it will cause the grip and the head of the hand tool to come loose, and then affect the use security. When adopting adhesive for fitting, the adhesive must be used to firstly well seal the fitting end of the grip and the mounting hole of the head of the hand tool close to the entry end for fitting, and then doing the encapsulation fitting, and even if there is but a tiny gap in this seal, the leakage of adhesive will be caused and the substandard products will be brought. After solidification of the adhesive, the adhesive used in sealing is then cleared away. Such procedure wastes not only time but labor, furthermore the solidification time of the adhesive is long, and it takes two days and nights to fit, encapsulate and package the hand tool, which needs long span of time in the working procedure, and easily has the defects in the working procedure, such as rustiness, smudginess and so one. In the inventive patent of “The Ax or Hammer with Firm Connection” with No. PCT/CN03/OO842 which is applied and published by the applicant on 30 Sep. 2003, an ax or hammer with firm connection is provided, including the grip with empty inside, reverse-wedgelike blind hole and reverse-wedgelike block of the ax or hammer head. The fitting end of the grip is located between the blind hole and the reverse-wedgelike block. Under the effect of the reverse-wedgelike block, the fitting end of the grip is deformed into the wedgelike shape same as the blind fitting hole, so greatly enhancing the resisting of pulling-out force and the use security of the ax or hammer, and prolonging more than 3 times of the service life. But the applicant finds in the practice that with regard to the ax or hammer with firm connection provided in PCT/CN03/00842, when the fitting hole adopts the circular reverse-wedgelike hole, although the resisting of pulling-out force is very big, the torsion-resistance intensity of the grip is not very big, but when the mounting hole adopts the reverse-wedgelike blind hole of squareness and ellipse, the fitted ax or hammer has big resisting of pulling-out force and big torsion-resistance intensity as well, but the manufacture of this hole is difficult, and it is hard to realize the quantity production with conventional process.

### CONTENTS OF THE INVENTION

Based on the above-mentioned facts, the aim of this invention is to provide an ax or hammer with the same pulling-out force as that mentioned in PCT/CN03/00842. The mounting hole of this ax or hammer is easy to be manufactured. And when adopting adhesive for fitting, the adhesive with high viscosity can be adopted, There is no need to seal the fitting end of the mounting hole. Furthermore there are other advantages including short production cycle, high rate of final products and good quality. The hand tool with firm connection according to this invention includes a head of hand tool (1) and a grip (2), the head of hand tool (1) having a mounting hole (11), and the grip (2) having a fitting end (21), characterized in that the fitting end (21) of the grip (2) has a cross section, the shape of which is formed by interconnecting several segments of arcs which have not the same center, with a reentrant (13) being formed at the place where the arcs are interconnected; the reentrants (13) of all cross sections form a longitudinal flute (23); the mounting hole (11) of the head of hand tool (1) is composed of several circular holes of which adjacent holes interconnect close to an entry end for fitting (S); the mounting hole (11) having a cross section close to the entry end for fitting (S) the shape of which is formed by interconnecting several segments of arcs which have not the same center, with a salient (25) being formed at the place where the arcs are interconnected; the salients (25) of all cross sections form a longitudinal convex arris (24). After the fitting, the convex arris (24) of the mounting hole (11) of the head of hand tool (1) is embedded into the flute (23) of the fitting end (21) of the grip (2).

Said mounting hole (11) of the head of hand tool (1) is the blind hole.

In said circular holes, there are at least two adjacent holes have the included angle more than zero degree. The distance between the centers of the at least two adjacent holes on the cross section close to the entry end for fitting (S) is less than that between the centers of the at least two adjacent holes on the cross section away from the entry end for fitting (S).

In said circular holes, there are at least two adjacent holes which are apart at certain depth away from the entry end for fitting (S). And on the cross section of this segment of hole of in which said at least two adjacent holes are apart, shapes of these two holes are both circles, with an interval (31) being provided between the adjacent circles, the interval (31) of each cross section forms a longitudinal partition wall (30) with the function of wedge. After fitting, the longitudinal partition walls (30) are embedded into the fitting end (21) of the grip (2).

There is at least one circular hole in the several circular holes constituting the mounting hole (11), which has a segment thereof close to the entry end for fitting (S) whose diameter is less than that of a segment of the hole that is away from the entry end for fitting (S).

At least one hole of said several circular holes composing the mounting hole (11) has a conic shape at certain depth from the entry end for fitting (S).

There is a wedge (3) which is fitted in the mounting hole (11).

The length of the wedge (3) is larger than the depth of the mounting hole (11).

In the grip (2), there is the longitudinal hole (22) at the center of each arc.

In the grip (2), there is a longitudinal plastic pin (32).

Mounting hole (11) is the through hole, there is a wedge (3) fitted in the mounting hole (11), and a counter bore (14) is made at another end (N) of the head of hand tool (1) opposite to the entry end for fitting (S). A sunk platform (5) is made at the back-end of the wedge (3), and after fitting, the sunk platform (5) is fitted into the counter bore (14).

There is an inner hole (8) in the wedgelike part (9) of said wedge (3).

There is the transverse through hole (29) made at the fitting end (21) of said grip (2), and there are pin slots (28) being made at both ends of the transverse through hole (29), and there is a plastic pin (27) fitted into the transverse through hole (29).

At another end (N) of the head of hand tool (1) opposite to the entry end for fitting (S), there is at least one longitudinal through hole (12), the size of which is smaller than the underside of the blind hole and which communicates with the mounting hole (11).

In the through hole (12) on said another end (N), there is a counter bore (14) being made at this another end (N).

There is a nail (6) installed in the through hole (12) of said another end (N), and this nail (6) has a wedgelike segment (9).

There is a screw made in a front-end of said nail (6), and there is a sunk platform (5) being made at its back-end. The length of the nail (6) is more than the gross length of the head of hand tool (1) and the grip (2) after fitting. The nail (6) extends through the head of hand tool (1) and the grip (2), and the screw (26) at its front-end comes out of the back-end of the grip, and is connected with the nut (7).

In the mounting hole (11), there is the counter bore (15) being made at the entry end for fitting (S).

There is adhesive (20) between the mounting hole (11) and the fitting end (21) of said grip (2).

There is a protecting layer (4) at the outer edge of said grip (2).

An ax or hammer with firm connection includes an ax or hammer head (1), a grip (2) and a wedge (3), and the grip (2) has a fitting end (21), the ax or hammer head (1) has a fitting hole (11), characterized in that: said grip (2) has a shape which is a straight barrel, the grip (2) is hollow inside and has a hole (22); the fitting end (21) of the grip (2) has a cross section, the shape of which is formed by interconnecting several segments of arcs which have not the same center.

There is a reentrant which is made at the place where the arcs are interconnected, and there is a longitudinal flute formed at the outer surface of the fitting end (21).

The fitting hole (11) is a through hole or blind hole, the fitting hole (11) has a bottom which is wedgelike shape and has an end that has a shape which is aa straight barrel, and the end has a cross section, the shape of which is the same as that of said fitting end (21).

With regard to said hole (22), there is one or more than one such hole.

The hole (22) is the through hole, and has a cylindrical shape.

The top of the wedge (3) has a wedgelike shape, and the bottom of the wedge has a cylindrical shape.

The length of said wedge (3) is greater than that of said fitting hole (11).

The wedge (3) and the hole (22) are in interference fit.

There is adhesive between said fitting end (21) and the fitting hole (11).

There is a protecting layer (4) at the outer edge of said grip (2).

With regard to the hand tool with firm connection according to this invention, after fitting, the convex arris of the mounting hole is embedded into the convex flute of the grip, like the spline connection, also in the mounting hole of this hand tool, there is the longitudinal partition wall being made, which is integrated with the hand tool and has the function of wedge. This longitudinal partition wall is embedded into the fitting end of the grip (2), and squeezes the fitting end of the grip (2) so as to make it deform into the same shape as the mounting hole. The mounting hole is made into the blind hole. Because both the mounting hole (11) and the fitting end (21) of the grip adopt the section type of connecting of the arcs, through the general processing ways, the mounting hole (11) and the fitting end (21) of the grip with this section type and high precision can be conveniently made. This fitting end (21) of the grip likes the piston rod, and the mounting hole (11) likes the cylinder with hydraulic pressure. There is the adhesive at the bottom of the blind hole. The normal fitting pressure of the grip is generally 2 tons, the cross sectional area of the fitting end (21) of the grip is 150 mm². When the fitting end (21) of the grip is pressed into the adhesive, the pressure of 1.33×10⁵ KPa can bring about, thus the adhesive with high treacliness, such as epoxy resin with treacliness of 0.32 Pa·S, can be fully filled into the inner gap of the fitting end (21) of the grip (2) as well as into the gap between the fitting end (21) and the mounting hole (11), but there is no need to add the thinner to reduce the treacliness of the epoxy resin to a certain degree, and then to do the filling. In such case without any thinner into the epoxy resin, the effect can be better, and in this fitting way, the adhesive with comparatively high treacliness can be used to fully fill the gap of the connecting parts. Also when fitting, there is no need to firstly seal the fitting end of the mounting hole (11), which has the advantages of saving time and labour, low rate of substandard products, and good quality of products. As long as the adhesive does not flow after fitting, it is unnecessary to do the packing after full solidification, so as to effectively shorten the time of working procedure, and avoid the rustiness and smudginess of the products in the working procedure. Moreover the connecting parts of such hand tool are not affected by outside factors, such as climate, environment, temperature, humidity and so forth, so as to avoid the volume shrink of the grip as well as the aging of the adhesive. At the same time because of the protection of the blind hole, during the usage, the outside force can not impact the connecting parts, so as to further improve the service life of the hand tool. Thus the hand tool has not only big pulling-out force but also big torsion resistance and flexural strength. Also the hand tool with firm connection according to this invention has the advantages of simple processing, low production cost, simplified assembly technique, firm connection and high security in use.

### BRIEF DESCRIPTION OF THE DRAWINGS

FIG. 1 is the cutaway view of the hand tool with firm connection according to the first preferred embodiment.

FIG. 2 is the C-C cutaway view of FIG. 1.

FIG. 3 is the cutaway view of the head of hand tool according to the first preferred embodiment.

FIG. 4 is the B-direction view of FIG. 3.

FIG. 5 is the view of the grip according to the first preferred embodiment.

FIG. 6 is the A-direction view of FIG. 5.

FIG. 7 is the E-E cutaway view of FIG. 5.

FIG. 8 is the cutaway view of the hand tool according to the second preferred embodiment.

FIG. 9 is the C-C cutaway view of FIG. 8.

FIG. 10 is the F-F cutaway view of FIG. 8.

FIG. 11 is the cutaway view of the head of hand tool according to the second preferred embodiment.

FIG. 12 is the B-direction view of FIG. 11;

FIG. 13 is the L-L-direction view of FIG. 11;

FIG. 14 is the view of the grip according to the second preferred embodiment;

FIG. 15 is the A-direction view of FIG. 14;

FIG. 16 is the E-E cutaway view of FIG. 14;

FIG. 17 is the cutaway view of the hand tool with firm connection according to the third preferred embodiment;

FIG. 18 is the C-C cutaway view of FIG. 17;

FIG. 19 is the cutaway view of the head of hand tool according to the third preferred embodiment;

FIG. 20 is the B-direction view of FIG. 19;

FIG. 21 is the view of the grip according to the third preferred embodiment;

FIG. 22 is the G-G cutaway view of FIG. 21;

FIG. 23 is the H-H cutaway view of FIG. 21;

FIG. 24 is the view of the plastic pin according to the third preferred embodiment;

FIG. 25 is the cutaway view of hand tool with firm connection according to the fourth preferred embodiment;

FIG. 26 is the C-C cutaway view of FIG. 25;

FIG. 27 is the cutaway view of the head of hand tool according to the fourth preferred embodiment;

FIG. 28 is the B-direction cutaway view of FIG. 27;

FIG. 29 is the view of the grip according to the fourth preferred embodiment;

FIG. 30 is the A-direction view of FIG. 29;

FIG. 31 is the E-E cutaway view of FIG. 29;

FIG. 32 is the cutaway view of the wedge according to the fourth preferred embodiment;

FIG. 33 is the cutaway view of the fifth preferred embodiment;

FIG. 34 is the cutaway view of the grip;

FIG. 35 is the front view of the wedge;

FIG. 36 is the left elevation of the grip;

FIG. 37 is the cutaway view of the ax or hammer head;

FIG. 38 is the B-B-direction cutaway view of the ax or hammer head;

FIG. 39 is the cutaway view of the sixth preferred embodiment;

FIG. 40 is the cutaway view of the grip;

FIG. 41 is the left elevation of the grip;

FIG. 42 is the main view of the wedge;

FIG. 43 is the cutaway view of the ax or hammer head;

FIG. 44 is the A-A-direction cutaway view of the ax or hammer head;

FIG. 45 is the cutaway view of the hand tool with firm connection according to the seventh preferred embodiment;

FIG. 46 is the C-C cutaway view of FIG. 45;

FIG. 47 is the cutaway view of the head of hand tool according to the seventh preferred embodiment;

FIG. 48 is the B-direction view of FIG. 47;

FIG. 49 is the view of the grip according to the seventh preferred embodiment;

FIG. 50 is the A-direction view of FIG. 49;

FIG. 51 is the E-E cutaway view of FIG. 49;

FIG. 52 is the cutaway view of the wedge according to the seventh preferred embodiment;

FIG. 53 is the D-direction view of FIG. 52;

FIG. 54 is the cutaway view of the hand tool with firm connection according to the eighth preferred embodiment;

FIG. 55 is the C-C cutaway view of FIG. 54;

FIG. 56 is the cutaway view of the head of hand tool according to the eighth preferred embodiment;

FIG. 57 is the B-direction view of FIG. 56;

FIG. 58 is the cutaway view of the grip according to the eighth preferred embodiment;

FIG. 59 is the A-direction view of FIG. 58;

FIG. 60 is the E-E cutaway view of FIG. 58;

FIG. 61 is the view of the nail according to the eighth preferred embodiment;

FIG. 62 is the cutaway view of the hand tool with firm connection according to the ninth preferred embodiment;

FIG. 63 is the C-C cutaway view of FIG. 62;

FIG. 64 is the cutaway view of the head of hand tool according to the ninth preferred embodiment;

FIG. 65 is the B-direction view of FIG. 64;

FIG. 66 is the cutaway view of the grip according to the ninth preferred embodiment;

FIG. 67 is the A-direction view of FIG. 66;

FIG. 68 is the E-E cutaway view of FIG. 66;

FIG. 69 is the cutaway view of the wedge according to the ninth preferred embodiment;

FIG. 70 is the view of the nail according to the ninth preferred embodiment;

FIG. 71 is the enlarged view of FIG. 62;

FIG. 72 is the cutaway view of hand tool with firm connection according to the tenth preferred embodiment;

FIG. 73 is the C-C-direction cutaway view of FIG. 72;

FIG. 74 is the cutaway view of the head of hand tool according to the tenth preferred embodiment;

FIG. 75 is the B-direction view of FIG. 74;

FIG. 76 is the cutaway view of the grip according to the tenth preferred embodiment;

FIG. 77 is the A-direction view of FIG. 76;

FIG. 78 is the E-E cutaway view of FIG. 77;

FIG. 79 is the part sectioned view of the nail according to the tenth preferred embodiment;

FIG. 80 is the view of the nut according to the tenth preferred embodiment.

### BRIEF DESCRIPTION OF THE REFERENCE SIGNS IN THE DRAWINGS

1 head of hand tool
2 grip
3 wedge
4 protecting layer
5 sunk platform of the nail
6 nail
7 binding nut
8 inner hole of the wedgelike-shaped part of the wedge
9 wedgelike-shaped part of the wedge
10 column at the bottom of the wedge
11 mounting hole
12 through hole of the end N
13 reentrant at the place where the arcs are interconnected
14 counter bore of the through hole at the bottom of mounting hole
15 counter bore at the entry end for fitting of the mounting hole
20 adhesive
21 fitting end of the grip
22 inner hole of the grip
23 flute at the fitting end of the grip
24 convex arris of the mounting hole
25 sectional salient of the mounting hole
26 screw of the nail
27 plastic pin
28 pin slot
29 transverse through hole
30 partition wall
31 interval
32 longitudinal plastic pin
S entry end for fitting
N another end of the head of hand tool (1) opposite the entry end for fitting S

The further explanation on this invention with reference to the attached figures is as follows:

### MODE FOR CARRYING OUT THE INVENTION

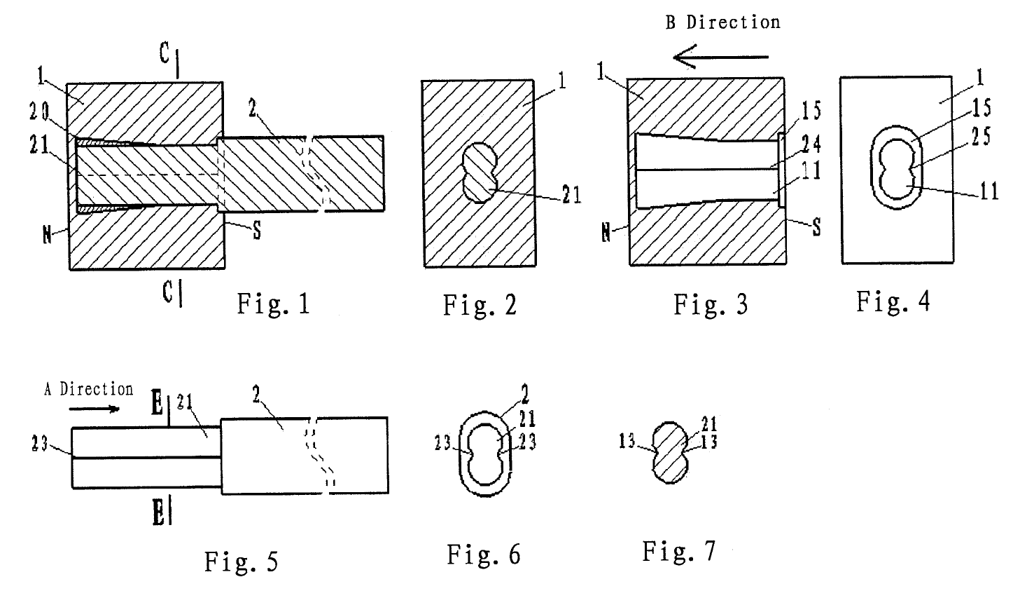

The first preferred embodiment of this invention, as shown in FIGS. 1 and 2, includes the head of hand tool (1) and the grip (2). As shown in FIGS. 3 and 4, the mounting hole (11) of the head of hand tool (1) is the blind hole formed by interconnecting two circular blind holes of big inside and small outside. The centerlines of both of the two holes are parallel with the centerline of the grip after fitting. Close to the entry end for fitting (S), these two circular blind holes have a cylindrical shape. Away from the bottom of the entry end for fitting (S), there is the reverse-conic blind hole which has a small end connecting with the cylindrical hole. The sectional shape of each segment of the mounting hole (11) is formed by interconnecting two segments of arcs which have not the same centers. At the place where the arcs are interconnected, there are two salients (25) being formed. The salient (25) of each section forms two longitudinal convex arrises (24), and the mounting hole (11) close to the top of the entry end for fitting (S) has a straight barrel shape. The sectional measurement of the hole away from the bottom of the entry end for fitting (S) is larger than that close to the top of the entry end for fitting (S), being the shape of big inside and small outside. And there is the counter bore (15) being made at the entry end for fitting (S). As shown in FIG. 5, FIG. 6 and FIG. 7, the sectional shape of the fitting end (21) of the grip (2) is formed by interconnecting two segments of arcs which have not the same centers. At the place where the arcs are interconnected, there is the reentrant (13) being formed. The reentrant (13) of each section forms the longitudinal flute (23) of the surface. As shown in FIG. 1 and FIG. 2, after fitting, the convex arris is embedded into the flute, and the grip (2) close to the forehead of the fitting end (21) is fitted into the counter bore (15). And there is the adhesive (20) being filled in the place of the connecting of the grip and the mounting hole, which is not only improve the torsion-resistance strength and the flexural strength but also reduce the production cost.

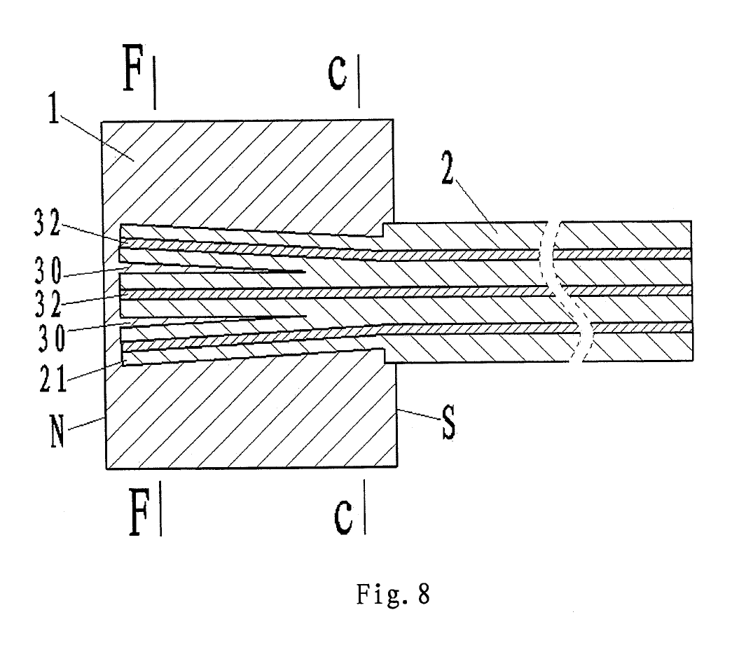

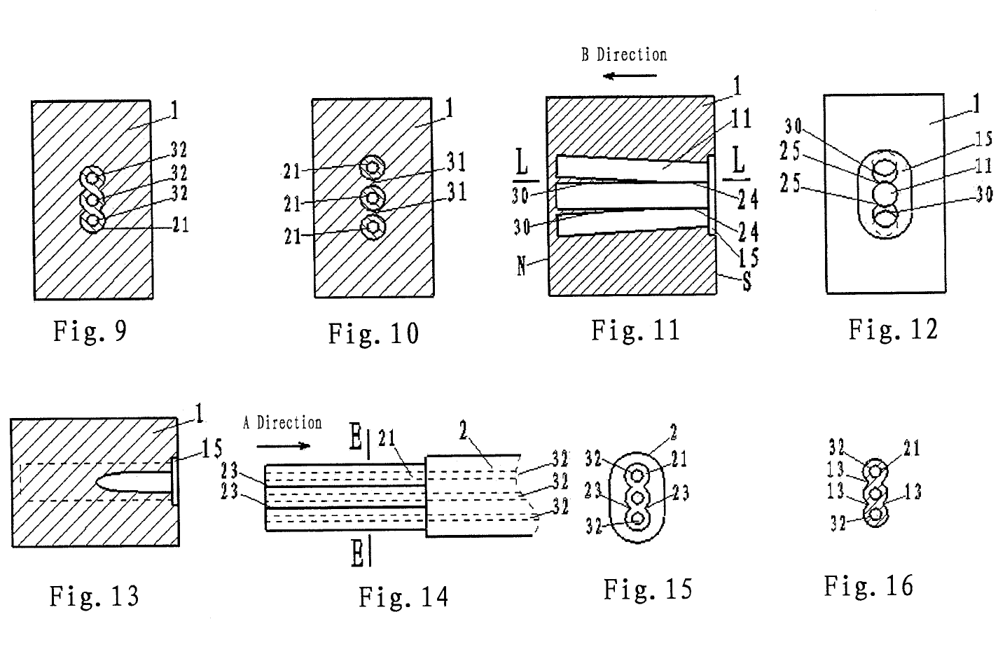

As shown in FIG. 8, FIG. 9 and FIG. 10, the second preferred embodiment of this invention includes the head of hand tool (1) and the grip (2). As shown in FIG. 11 and FIG. 12, the mounting hole (11) of the head of hand tool (1) is the blind hole. And the mounting hole (11) is composed of three circular blind holes, in which the centerline of the middle hole coincides with the centerline of the grip after fitting, and both of another two holes interconnect with the middle hole at the entry end for fitting (S). As shown in FIG. 11 and FIG. 12, the sectional shape of the mounting hole (11) at the entry end for fitting (S) is formed by interconnecting several segments of arcs which have not the same centers. And the distance of the centers of the adjacent two arcs is less than the sum of the radiuses of these two arcs. At the place where the arcs are interconnected, there is the salient (25) being formed, and the salient (25) of each cross section forms the longitudinal convex arris. And as shown in FIG. 8, FIG. 10, FIG. 11, FIG. 12 and FIG. 13, these three cylindrical blind holes are apart at certain depth from the entry end for fitting (S). The distance of the centers of the two adjacent arcs on the F-F cross section of this segment of hole at the place of the parting of these three holes is greater than the sum of the radiuses of these two arcs. And these two arcs form a circle. There is a segment of interval (31), formed by the material of the head of hand tool (1), between the two adjacent circles. And the interval (31) of each cross section forms the longitudinal partition wall (30) with the function of wedge. There is a counter bore (15) being made at the entry end for fitting (S). As shown in FIG. 14, FIG. 15 and FIG. 16, the cross sectional shape of the fitting end (21) of the grip (2) is formed by interconnecting four segments of arcs which have not the same centers. At the place of interconnecting the four segments of arcs, there is the reentrant (13) being formed. And the reentrant (13) of each section forms the longitudinal flute (23). Inside of the grip (2), there are several longitudinal plastic pins (32). After fitting, as shown in FIG. 8, FIG. 9 and FIG. 10, the convex arris (24) is embedded into the flute (23). The fitting end (21) of the grip (2) firstly contacts the longitudinal partition wall (30) at the bottom of the mounting hole (11). When the grip is sequentially enclosed, the partition wall (30) will then cleave the fitting end of the grip (2) into three parts. And the partition wall (30), just like a wedge integrated with the head of hand tool, is lengthways embedded into the fitting end (21). In order to prevent the fitting end (21) of the grip (2) from the rupture of its fiber when being cleft by the partition wall (30), inside of the grip (2), there is several longitudinal plastic pins (32). Because of the squeezing of the partition wall (30), the fitting end (21) is deformed into the same shape as the mounting hole (11). There is the adhesive between the fitting end (21) and the mounting hole (11), so as to make the grip (2) firmly combine with the hammerhead (1).

There is the counter bore (15) made at the entry end for fitting (S), which is convenient for the fitting of the grip with handsome joint. At the outside of the grip (2), there is the protecting layer (4) which is made of the plastic material belonging to the category of rubber, which can absorb the wallop during the use.

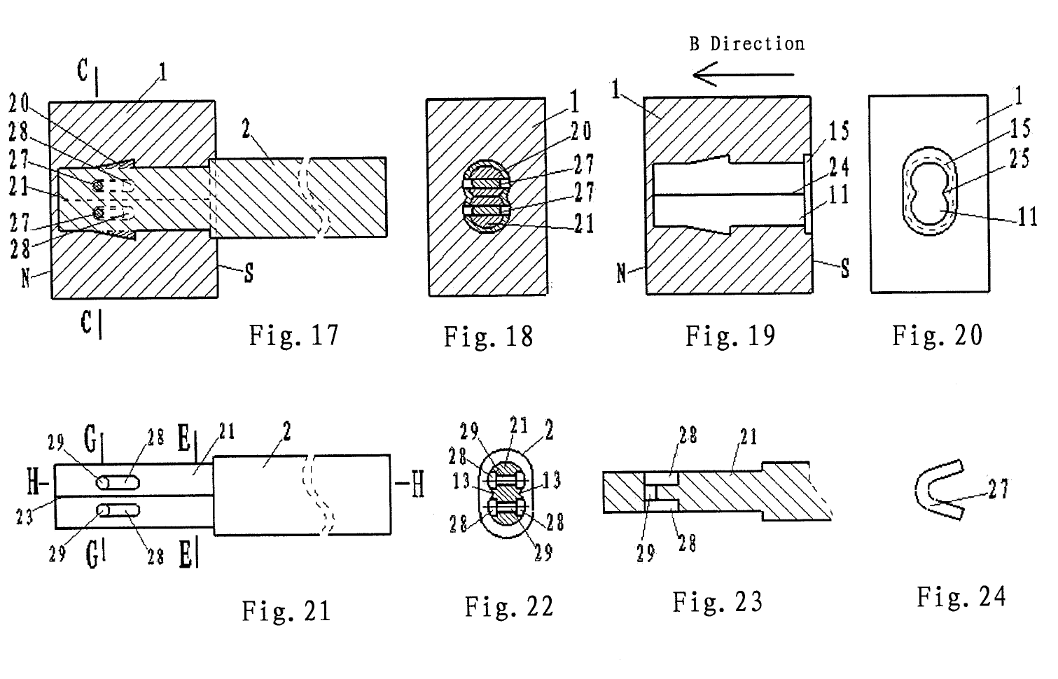

As shown in FIG. 17 and FIG. 18, the third preferred embodiment of this invention includes the head of hand tool (1), the grip (2) and two plastic pins (27). As shown in FIG. 19 and FIG. 20, the mounting hole (11) of the head of hand tool (1) is the blind hole which is formed by interconnecting two circular blind holes with big inside and small outside. Both of the centerlines of the holes are parallel with the centerline of the grip after fitting. Each of the sectional shape of the mounting hole (11) is formed by interconnecting two segments of arcs which have not the same centers. At the place where the arcs are interconnected, there is the salient (25) being formed. And the salient (25) of each section forms the longitudinal convex arris (24). The sectional measurement of the entry end for fitting (S) close to the mounting hole (11) is less than that of one segment of hole at the medium part of the mounting hole (11), being the shape of big inside and small outside. There is a counter bore (15) being made at the entry end for fitting (S). As shown in FIG. 21, FIG. 22 and FIG. 23, the sectional shape of the fitting end (21) of the grip (2) is formed by interconnecting the two segments of arcs which have not the same centers. And there is the reentrant (13) being formed at the place where the arcs are interconnected. The reentrant (13) of each section forms the longitudinal flute (23). At the fitting end (21), there is the transverse through hole (29) being made. And at both of the ends of the transverse through hole (29), there is the pin slot (28) being made. As shown in FIG. 24, the plastic pin (27) is the plastic split pin with the shape of “U”. When pressed, the size of the opening will then narrow; after the press is removed, the size of the opening will widen. After fitting, the plastic pin (27) is fitted into the hole (29) and is made its opening backwards. Then after the fitting end (21) of the grip (2) is fitted into the mounting hole (11), the convex arris (24) is embedded into the flute (23). And when the plastic pin is embedded into the top of the mounting hole (11), the plastic pin (27) is pressed, and then sinks into the pin slot (28). When the plastic pin (27) is fitted into the proper position, it locates at the mounting hole of its medium part with comparatively big sectional measurement. Because of the elasticity, at this time the plastic pin still closely joints with the wall of the hole. Through the plastic pin (27), the fitting end (21) of the grip (2) is blocked in the mounting hole (11), so as to prevent from looseness. At the entry end for fitting (S), there is the counter bore (15) being made, which is beneficial to not only the fitting as well as the handsome joint. And there is the adhesive filled into the place of the connecting of the grip and the mounting hole, so as to reinforce the connecting strength.

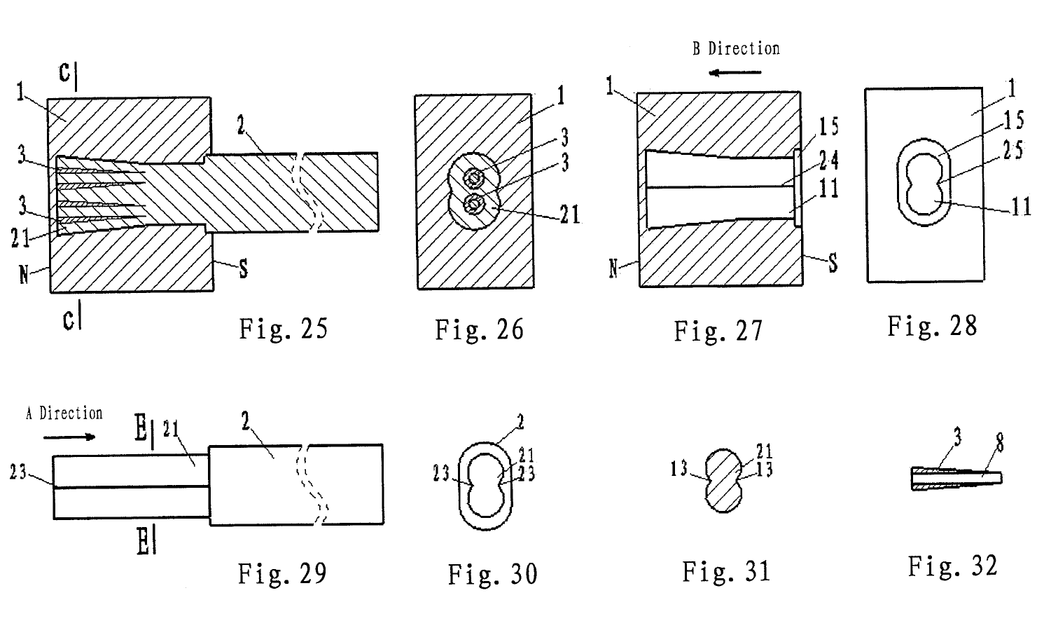

As shown in FIG. 25 and FIG. 26, the fourth preferred embodiment of this invention includes the head of hand tool (1), the grip (2) and the wedge (3). As shown in FIG. 27 and FIG. 28, the mounting hole (11) of the head of hand tool (1) is the blind hole which is formed by interconnecting two blind holes which have cylindrical shape close to the entry end for fitting (S) and are reverse-conic away from the entry end for fitting (S), and whose centerlines are parallel with the centerline of the grip after fitting. Each sectional shape of the mounting hole (11) is formed by interconnecting two segments of arcs which have not the same center. At the place where the arcs are interconnected, there is the salient (25) being formed. And the salient (25) of each section forms the longitudinal convex arris (24). The bottom of the mounting hole (11) is wedgelike, and its top has a straight barrel shape. There is the counter bore (15) being made at the entry end for fitting (S). As shown in FIG. 29, FIG. 30 and FIG. 31, the sectional shape of the fitting end (21) of the grip (2) is formed by interconnecting two segments of arcs which have not the same center. At the place where the arcs are interconnected, there is the reentrant (13) being formed. The reentrant (13) of each section forms the longitudinal flute (23) of the surface. As shown in FIG. 32, there is the inner hole (8) in the wedge (3), thus the wedge (3) can then be comparatively easily nailed into the entry end for fitting (21) of the grip (2). When fitting, the wedge (3) is firstly nailed lengthways into certain depth of the fitting end (21) of the grip (2), and then the grip is fitted into the mounting hole (11). When the top of the wedge (3) contacts the bottom of the mounting hole (11), the wallop of the grip can fully nail the wedge (3) into the entry end for fitting (21) of the grip (2). As shown in FIG. 25 and FIG. 26, under the squeezing of the wedge (3), the entry end for fitting (21) is deformed, whose top becomes wedgelike. Because the inside of the wedge (3) is empty, and its inner hole (8) is filled with the material of the grip, thus the wedge (3) is not easy to work itself loose from the entry end for fitting.

There is the counter bore being made at the entry end for fitting (S), so as to be convenient for the fitting and make handsome joint.

There is adhesive at the place of connecting of the fitting end (21) of the grip and the mounting hole (11), thus the connecting strength is further reinforced.

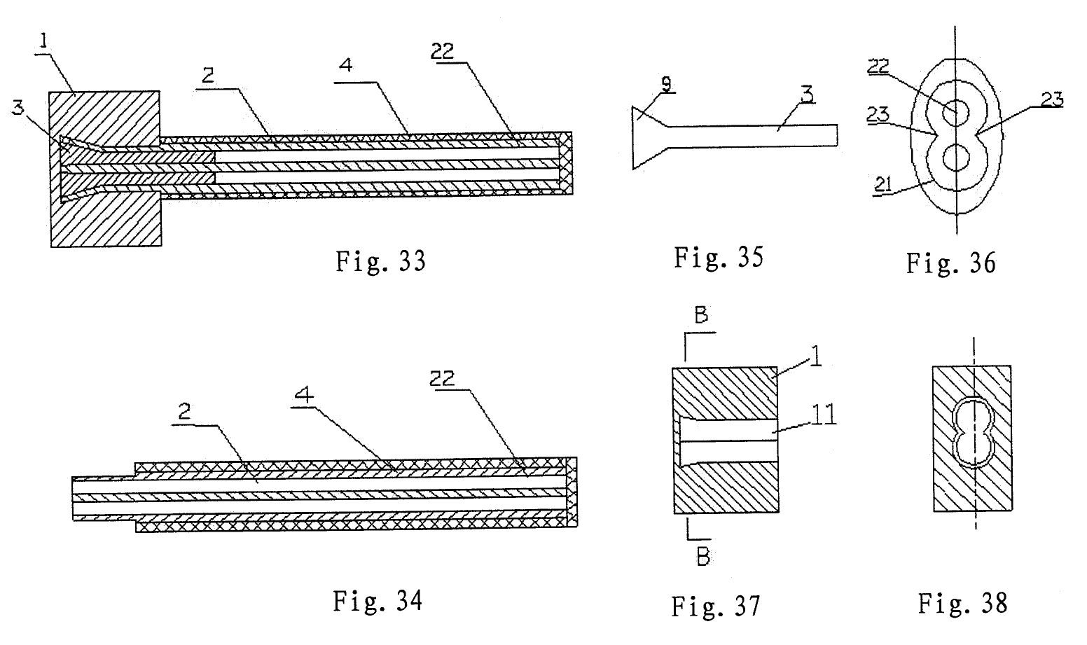

As shown in FIG. 33-38, in the fifth preferred embodiment of this invention, the fitting hole (11) of the ax or hammer head (1) is the blind hole. As shown in FIG. 36, the fitting end (21) of the grip is two arcs, whose centers are not the same but both on the centerline of the grip. At the place of connecting of the arcs, there is the reentrant being formed. And on the outer surface of the fitting end (21), there are two longitudinal flutes (23) being formed.

This implementation includes the ax or hammer head (1), the grip (2) and the wedge (3). As shown in FIG. 34, the inside of the grip (2) is empty and has two through holes (22) which both have the cylindrical shape. The grip which is hollow inside can reduce the conduction of wallop during the use, so as to bring down the discomfort of the user.

As shown in FIGS. 33 and 36, the ax or hammer head (1) has the fitting hole (11) whose bottom is wedgelike and whose top has a straight barrel shape, and the sectional shape of the top is the same as that of said fitting end (21). The fitting hole 11 is the blind hole. As shown in FIG. 35, the top of the wedge 3 is wedgelike, and its bottom has cylindrical shape. And the length of the

wedge 3 is greater than that of said fitting hole 11. As shown in FIG. 33, the wedge 3 extends into the grip 2 with some distance, so as to reinforce the strength of the connecting of the grip and the ax or hammer head, and prevent the fitting end from breaking during the use. When fitting, the cylindrical bottom of the wedge 3 is inserted into the hole 22, and the wedgelike top remains outside of the hole 22. And the fitting end 21, which is installed with the wedge 3, is fitted into the fitting hole 11, so at the make the top of the wedge 3 contact the bottom of the fitting hole 11. And then with wallop, the fitting end 21 is installed into the fitting hole 11. Under the function of the wallop, the wedge 3 is fully nailed into the hole 22. And the fitting end 21 is deformed under the squeezing of the wedgelike top of the wedge 3, and the top of the fitting end 21 becomes wedgelike. The top of the wedge 3 has the proper shape, so as to make the shape of the fitting end 21, after its deformation, same as that of the bottom of the fitting hole 11, thus the grip 2 firmly combines with the ax or hammer head 1. The length of the wedge 3 is greater than that of the fitting hole, this the wedge can extend into the grip with certain distance, so as to reinforce the strength of the fitting end and prevent the fitting end 21 from breaking during the use.

There is adhesive between the fitting end 21 and the fitting hole 11.

There is the protecting layer 4 at the outside of the grip 2, which is made of the plastic material belonging to the category of rubber, so as to absorb the wallop during the use.

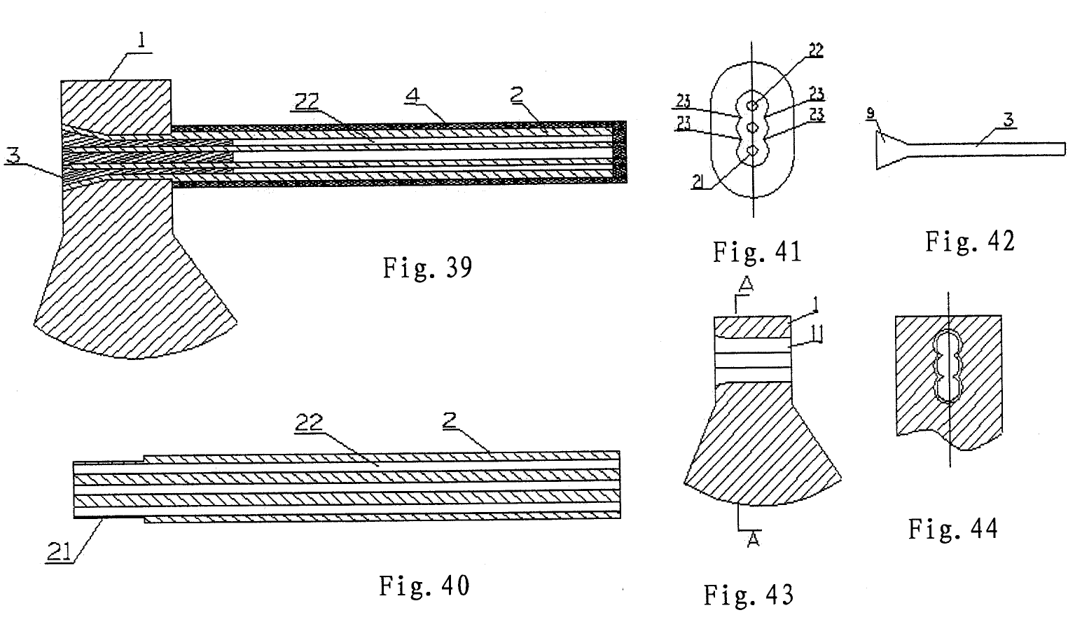

As shown in FIG. 39-44, in the sixth preferred embodiment of this invention, the fitting hole 11 of the ax or hammer head 1 is the through hole. The section of the fitting end 21 of the grip in this embodiment is as shown in FIG. 41, which is composed of four arcs, whose centers are not the same but all on the centerline of the grip. At the place of connecting of the arcs, there is the reentrant being formed. And on the outer surface of the fitting end 21, there are four longitudinal flutes 23 being formed. This embodiment includes the ax or hammer head 1, the grip and the wedge 3. As shown in FIG. 40, the grip 2 has a straight barrel shape, and the grip 2 is hollow inside and has three through holes 22 which have cylindrical shape. The grip which is hollow inside can reduce the conduction of the wallop during the use, and can bring down the discomfort of the user.

As shown in FIGS. 43 and 44, the ax or hammer head 1 has the fitting hole 11 whose bottom is wedgelike and whose top has a straight barrel shape, and whose sectional shape of at the top is the same as the sectional shape of said fitting end 21; the fitting hole 11 is the through hole. As shown in FIG. 42, the wedge 3 has a wedgelike top and a cylindrical bottom, and its length is greater than that of said fitting hole 11. As shown in FIG. 39, the wedge 3 extends into the grip 2 with certain distance, so as to reinforce the strength of the connection of the grip and the ax or hammer head, and prevent the fitting end from breaking during the use. When fitting, the fitting end 21 of the grip 2 is firstly inserted into the fitting hole 11 of the ax or hammer head 1, and then the wedge 3 is inserted into the hole 22, and the wedge 3 is fully nailed into the hole 22 under wallop. Because the top of the wedge 3 is wedgelike, its nailing into the hole 22 can cause the top of the hole 22 to deform. The top of the wedge 3 has the proper shape, so as to make the shape of the top of the fitting end 21, after its deformation, same as that of the bottom of the fitting hole 11, thus the grip 2 can firmly combine with the ax or hammer head. The length of the wedge 3 is greater than that of the fitting hole, thus the wedge can extend into the grip with certain distance, so as to reinforce the strength of the fitting end and prevent the fitting end 21 from breaking during the use.

There is adhesive between the fitting end 21 and the fitting hole 11.

There is the protecting layer 4 at the outside of the grip 2, which is made of the plastic material belonging to the category of rubber, so as to absorb the wallop during the use.

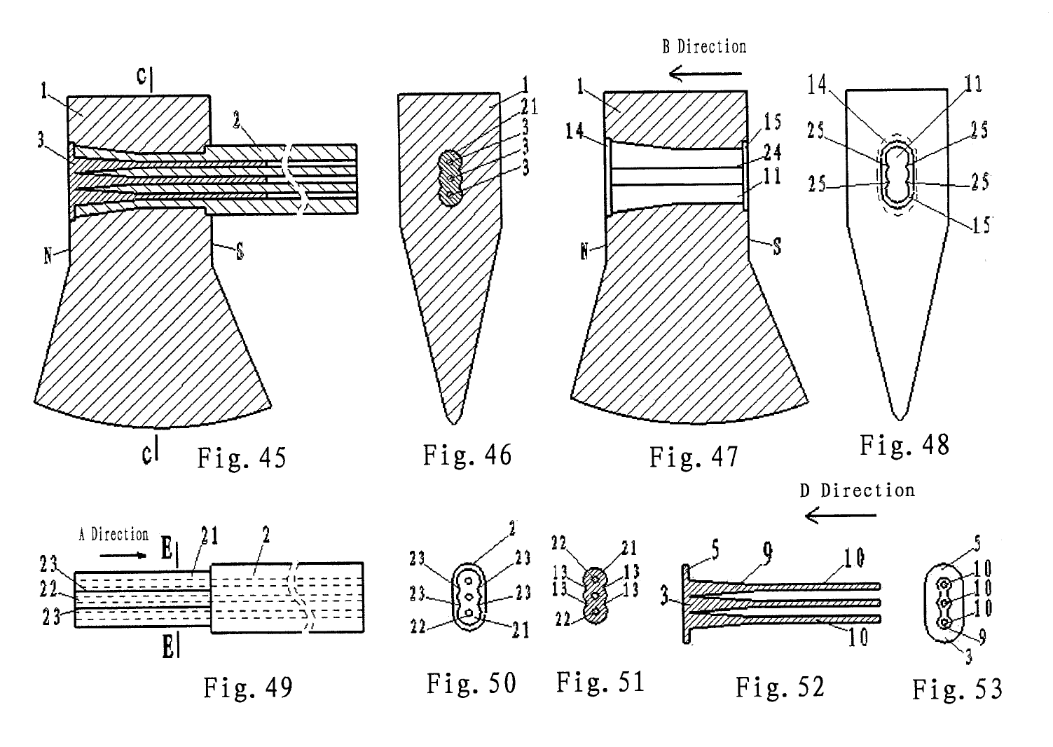

As shown in FIG. 45 and FIG. 46, the seventh preferred embodiment of this invention includes the head of hand tool (1), the grip (2) and the wedge (3). As shown in FIG. 47 and FIG. 48, the mounting hole (11) of the head of hand tool (1) is the through hole, which is formed by interconnecting three through holes, which have cylindrical shape close to the entry end for fitting (S) and are reverse-conic away from the entry end for fitting (S), and the centerlines of which are all parallel with the centerline of the grip after fitting. Each sectional shape of the mounting hole (11) is formed by interconnecting four segments of arcs which have not the same center. At interconnecting the arcs, there is the salient (25) being formed. The salient (25) of each section forms four longitudinal convex arrises (24). There is the counter bore (15) made at the entry end for fitting (S) of the mounting hole (11). And there is also the counter bore (14) made another end (N) of the head of hand tool (1) opposite the entry end for fitting (S). The end of mounting hole (11) close to the entry end for fitting has a straight barrel shape, and close to the end (N) is wedgelike. As shown in FIG. 49, FIG. 50 and FIG. 51, the sectional shape of the fitting end (21) of the grip (2) is formed by interconnecting four segments of arcs which have not the same center. At interconnecting the arcs, there is the reentrant (13) being formed. The reentrant (13) of each section forms four longitudinal flutes (23). The grip (2) has a straight barrel shape and has three longitudinal through holes (22), which have cylindrical shape. The grip which is hollow inside can reduce the conduction of the wallop during the use, and make use more comfortable.

As shown in FIG. 52 and FIG. 53, there is the sunk platform made at the back-end of the wedge (3). The sectional shape of this sunk platform (5) is the same as that of the counter bore (14) of the head of hand tool. There is the wedgelike part (9) on the sunk platform (5), on the front-end of which there are three columns 10 being made, the size and position of which are all compatible with the hole (22) of the fitting end of the grip (2). And the length of the wedge (3) is greater than that of the mounting hole (11) of the head of hand tool.

When fitting, the fitting end (21) of the grip (2) is firstly fitted into the mounting hole (11) of the head of hand tool (1), and the convex arris (24) of the mounting hole (11) is embedded into the flute (23) of the grip. And then the three columns 10 of the wedge (3) are respectively inserted into the three holes (22) of the grip (2), and nailed into the grip (2). And the wedgelike parts (9) are sequentially nailed into the entry end for fitting (21) of the grip (2) under wallop. Because of the squeezing of the wedgelike part (9), the top of the entry end for fitting (21) is deformed into wedgelike shape. After fitted into proper position, the sunk platform (5) of the wedge (3) sinks into the counter bore (14). Because the columns of the wedge (3) are nailed into the grip (2), the wedgelike part (9) squeezes the entry end for fitting and deforms it into the wedgelike shape same as the bottom of the mounting hole, thus not only the head of hand tool coming loose can be effectively prevented but also the wedge (3) plays the role of sealing for the mounting hole.

At the entry end for fitting (S), there is the counter bore (15) being made, which is good for convenient fitting of the grip and handsome joint.

There is adhesive between the fitting end (21) and the mounting hole (11).

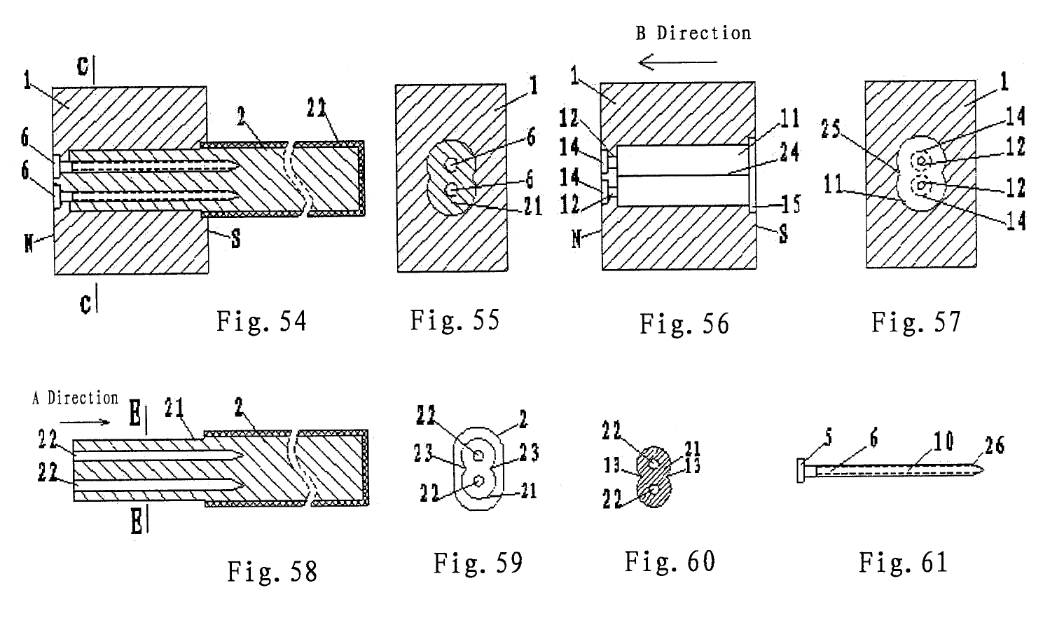

As shown in FIG. 54 and FIG. 55, the eighth preferred embodiment of this invention includes the grip (2), the head of hand tool (1) and the nail (6). As shown in FIG. 58, FIG. 59 and FIG. 60, the shape of the cross section of the fitting end (21) of the grip (2) is formed by interconnecting two arcs which have not the same center. At the place where the arcs are interconnected, there are two reentrants (13) being formed. The reentrant (13) of each section forms two longitudinal flutes (23) at the outer surface of the entry end for fitting (21). There are the holes (22) being made at the fitting end of the grip (2), which are convenient for the enclosing of nails. As shown in FIG. 56 and FIG. 57, the head of hand tool (1) has the mounting hole (11) which is formed by interconnecting two cylindrical blind holes, the centerlines of which are both parallel with the centerline of the grip after fitting. The shape of each section of the mounting hole (11) is formed by interconnecting two segments of arcs which have not the same center. The sectional shape of the mounting hole (11) is the same as that of said entry end for fitting (21), being the blind hole with the shape of a straight barrel. At the underside of the blind hole, there are two through holes (12) being made. There is the counter bore (14) being made on the through hole (12) at another end (N) of the head of hand tool (1) opposite to the entry end for fitting (S). As shown in FIG. 61, on the pole of the nail (1O) of the nail (6), there is the screw (26) made to prevent from looseness, and at the back-end, there is the sunk platform (5) being made. The length of the nail (6) is greater than that of the mounting hole. As shown in FIG. 54, the nail (6) extends into the grip (2) with certain distance. When fitting, the fitting end (21) of the grip is embedded into the mounting hole (11), and then the nail (6) goes through the through hole (12) via the end (N) of the head of hand tool with counter bore (14), and is nailed into the grip (2). After this, the sunk platform (5) of the nail (6) is fitted into the counter bore (14) of the end (N) of the head of hand tool (1). And the head of the hand tool (1) is then connected with the grip (2) with firmness and smoothness.

There is the counter bore (15) being made at the entry end for fitting (S), which is good for not only the fitting of the grip (2) but also handsome joint.

There is adhesive between the fitting end (21) and the mounting hole (11).

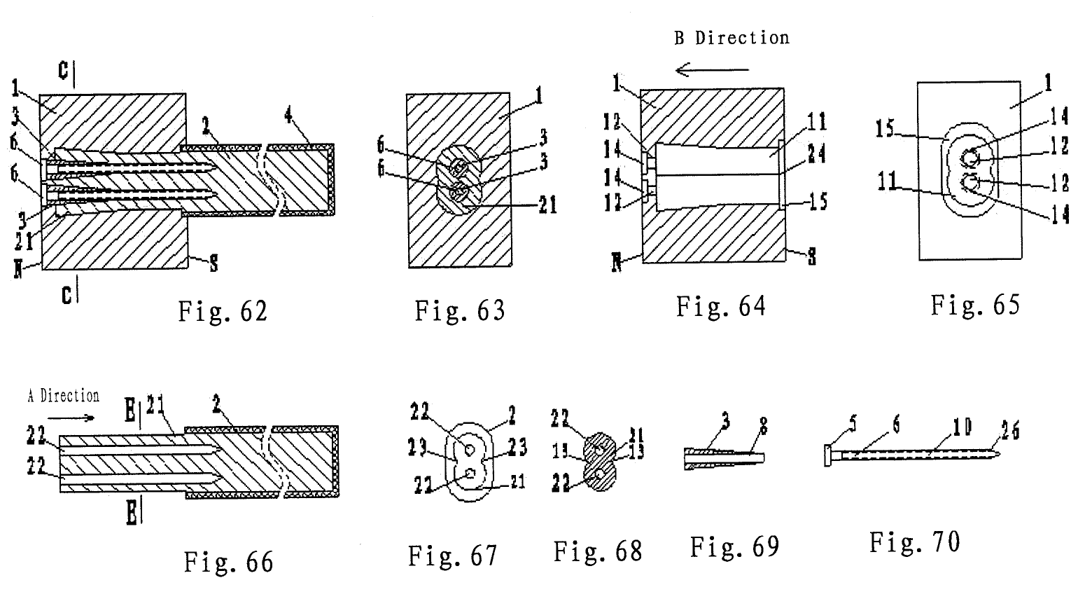

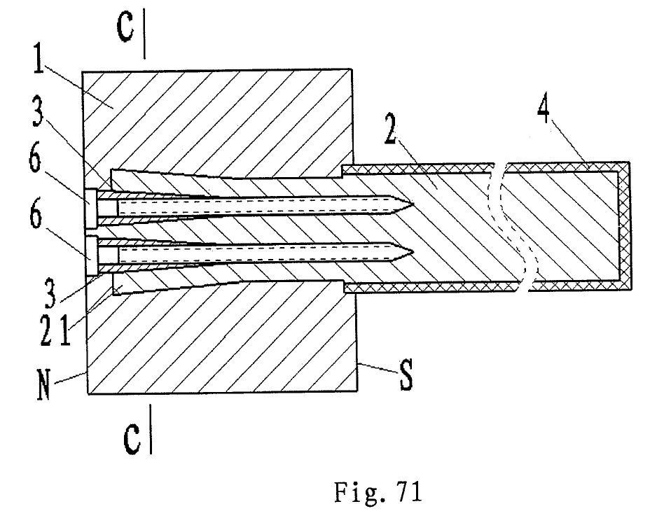

As shown in FIG. 62, FIG. 63 and FIG. 71, the ninth preferred embodiment of this invention includes the grip (2), the head of hand tool (1), the wedge (3) and the nail (6). As shown in FIG. 66, FIG. 67 and FIG. 68, the shape of cross section of the entry end for fitting (21) of the grip (2) is formed by interconnecting two arcs which have not the same center. At the place where the arcs are interconnected, there are two reentrants (13) being formed. The reentrant (13) of each section forms two longitudinal flutes (23) at the outer surface of the entry end for fitting (21). At the fitting end of the grip (2), there is the hole (22) being made, which is convenient to fit the nail. As shown in FIG. 64 and FIG. 65, the mounting hole (11) of the head of hand tool (1) is the blind hole which is formed by interconnecting two blinds holes which have cylindrical shape close to the entry end for fitting (S) and are reverse-conic away from the entry end for fitting (S). The centerlines of the two holes are both parallel with the centerline of the grip after fitting. Each sectional shape of the mounting hole (11) is formed by interconnecting two segments of arcs which have not the same center. At the place where the arcs are interconnected, there is the salient (25) being formed. The salient of each section forms the longitudinal convex arris (24). The bottom of the mounting hole (11) is wedgelike, and the top of the mounting hole has a straight barrel shape. The mounting hole (11) is the blind hole. There are two through holes (12) at another end (N) of the head of hand tool (1) opposite the entry end for fitting. The central positions of these through holes (12) have the superposition with the holes (22) of the fitting end (21) of the grip (2) after fitting. There is the counter bore (14) of the through hole (12) being made at the end (N). At the entry end for fitting (S), there is the counter bore (15) being made in the head of hand tool (1). As shown in FIG. 69, there is the inner hole (8) in the wedge (3). And as shown in FIG. 70, at the front-end of the nail (6), there is the screw (26) made to prevent from looseness, and at the back-end, there is the sunk platform (5) being made.

And the sectional size of its pole (10) is less than that of the inner hole of the through hole (12) and the wedge (3). The length of the nail (6) is greater than that of the mounting hole. As shown in FIG. 62, the nail extends into the grip (2) with certain distance. When fitting, after the fitting end of the grip (2) is fitted into the mounting hole (11), the wedge (3) goes through the through hole (12) via the end (N) of the head of hand tool (1), and then is nailed into the fitting end (21) of the grip (2). Under the squeezing of the wedgelike part of the wedge (3), the fitting end (21) deforms. After this, the shape of the fitting end is the same as the bottom of the mounting hole (11), so as to make the grip (2) firmly combine with the head of hand tool (1). Then the nail (6) goes through the through hole (12) via the end (N) of the head of hand tool (1), and is fitted into the grip (2) through the inner hole (8) of the wedge (3) which has been fitted into the grip (2). When the nail is fitted into the proper position, the sunk platform (5) of the nail (6) is fitted into the counter bore (14) of the end (N) of the head of hand tool (1). Thus the nail (6) can not only prevent the wedge from coming loose but also further make the head of hand tool (1) firmly connect with the grip (2).

At the entry end for fitting of the mounting hole (11), there is the counter bore being made, which is good for not only the fitting of the grip but also nice looking joint.

There is the adhesive between the fitting end (21) and the mounting hole (11).

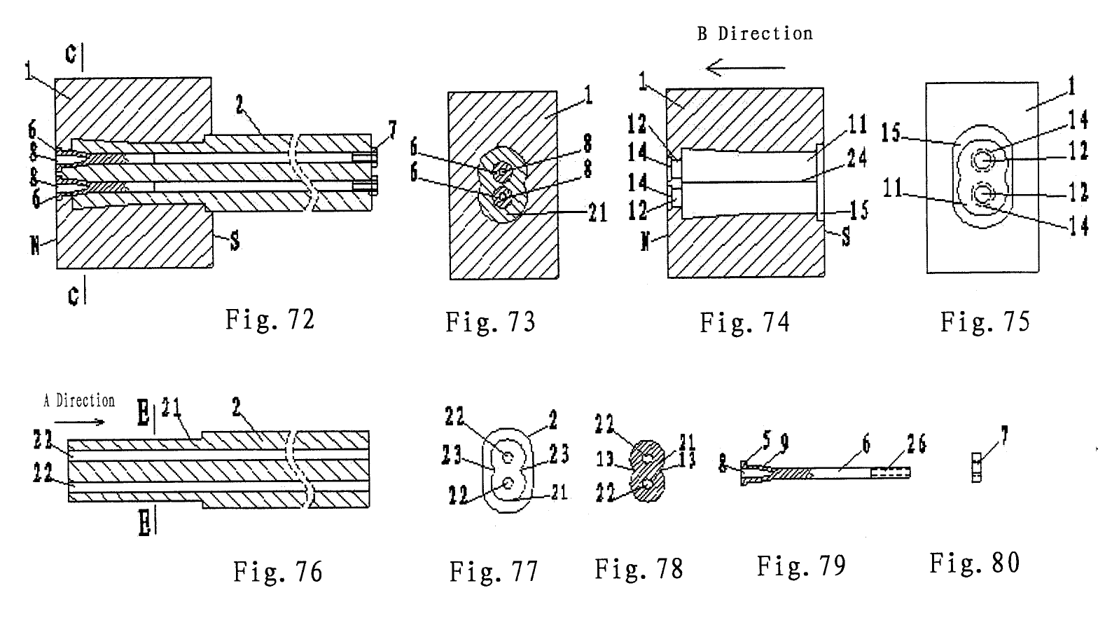

As shown in FIG. 72 and FIG. 73, the tenth preferred embodiment of this invention includes the grip (2), the head of hand tool (1) and the nail (6). As shown in FIG. 76, FIG. 77 and FIG. 78, the shape of the cross section of the fitting end (21) of the grip (2) is formed by interconnecting two arcs which have not the same center. At the place where the arcs are interconnected, there are two reentrants (13) being formed. The reentrant (13) of each section forms two longitudinal flutes (23) on the outer surface of the entry end for fitting (21). The grip has a straight barrel shape and is formed thereon with two longitudinal cylindrical through holes (22) which is convenient for the fitting of the wedgelike nail (6). As shown in FIG. 74 and FIG. 75, the mounting hole (11) of the head of hand tool (1) is the blind hole which is formed by interconnecting two blind holes which have a cylindrical shape close to the entry end for fitting (S) and are reverse-conic away from the entry end for fitting (S). The centerlines of these two holes are both parallel with the centerline of the grip after fitting. Each sectional shape of the mounting hole (11) is formed by interconnecting two segments of arcs which have not the same center. At the place where the arcs are interconnected, there is the salient (25) being formed. The salient (25) of each section forms longitudinal convex arris (24). The bottom of the mounting hole (11) is wedgelike, and the top of the mounting hole has a straight barrel shape. The mounting hole (11) is the blind hole. There are two through holes (12) being made at another end N of the head of hand tool (1) opposite the entry end for fitting S. The central positions of these through holes (12) have superposition with the hole (22) of the fitting end (21) of the grip (2) after fitting. At the end (N), there is the counter bore (14) of the through hole (12) being made. And at the entry end for fitting (S) of the head of hand tool (1), there is the counter bore (15) being made. As shown in FIG. 79, there is the screw (26) being made at the front-end of the nail (6), and at its back-end, there is the sunk platform (5) being made. Close to the inside of the sunk platform (5), there is the wedge (9) being made. For the convenience of the production, the sunk platform (5) and the wedgelike part are made into the inner hole (8). And the length of the nail (6) is greater than the gross length of the head of hand tool and the grip after fitting. As shown in FIG. 72, the screw (26) of the front-end of the nail (6) goes through the head of hand tool (1) and the grip (2), and comes out of the back-end of the grip (2) with certain distance. When fitting, the grip is fitted into the mounting hole (11), and the nail (6) goes through the through hole (12) from the end N of the head of hand tool (1), and is fitted into the inner hole (22) of the grip. After the nail is fitted into the proper position, the sunk platform (5) of the nail (6) in fitted into the counter bore (14) of the end N. Under the squeezing of the wedgelike part of the nail (6), the fitting end (21) of the grip (2) is deformed into the same wedgelike shape as the bottom of the mounting hole (11), so as to make the grip (2) firmly combine with the head of hand tool (1). The body of the nail (6) goes through the grip (2), and the screw (26) of its front-end comes out of the back-end of the grip with certain length. The nut (7) is crewed down onto the screw (26), thus through the nut (7) and the screw (26) of the nail (6), the head of hand tool (1) is firmly connected with the grip (2). And the column part (10) of the nail (6) plays the role of reinforcing bar for the grip, so as to further heighten the connection strength, prevent the grip from breaking at any place during the use, and further ensure the firm connection of the head of hand tool (1) and the grip (2). At the entry end for fitting of the mounting hole (11), there is the counter bore being made, which is good for the fitting of the grip and nice looking joint.

There is adhesive between the fitting end (21) and the mounting hole (11).

1. A hand tool with firm connection, includes a head of hand tool and a grip; the head of hand tool having a mounting hole, and the grip having a fitting end; characterized in that the fitting end of the grip has a cross section, the shape of which is formed by interconnecting several segments of arcs which have not the same center, with a reentrant being formed at the place where the arcs are interconnected; the reentrants of all cross sections form a longitudinal flute; the mounting hole of the head of hand tool is composed of several circular holes of which adjacent holes interconnect close to an entry end for fitting (S); the mounting hole having a cross section close to the entry end for fitting (S) the shape of which is formed by interconnecting several segments of arcs which have not the same center, with a salient being formed at the place where the arcs are interconnected; the salients of all cross sections form a longitudinal convex arris; after fitting, the convex arris of the mounting hole of the head of hand tool being embedded into the flute of the fitting end of the grip.

2. The hand tool with firm connection according to claim 1 characterized in that the mounting hole of said head of hand tool is a blind hole.

3. The hand tool with firm connection according to claim 1 or 2 characterized in that there are at lest two adjacent holes in said circular holes, which have an included angle of more than zero degree therebetween; a distance of centers of said at least two adjacent holes on a cross section close to the entry end for fitting being less than a distance of centers of said at least two adjacent holes on a cross section away from the entry end for fitting.

4. The hand tool with firm connection according to claim 3 characterized in that in said circular holes, at least two adjacent holes are apart at certain depth from the entry end for fitting; on the cross section of this segment of hole in which said at least two adjacent parting holes are apart, shapes of these at least two holes are both circles with an interval being provided between the adjacent circles; and the interval of each cross section forms a longitudinal partition wall with a function of wedge; after fitting, the longitudinal partition wall is embedded into the fitting end of the grip.

5. The hand tool with firm connection according to claim 1 or 2 characterized in that of the several circular holes composing said mounting hole, there is at least one circular hole, which has a segment of the hole close to the entry end for fitting whose diameter is less than the diameter of a segment of the hole that is away from the entry end for fitting.

6. The hand tool with firm connection according to claim 5 characterized in that at least one hole of the several circular holes composing the mounting hole is conic at certain depth from the entry end for fitting.

7. The hand tool with firm connection according to claim 1 or 2 characterized in that a wedge is fitted in said mounting hole.

8. The hand tool with firm connection according to claim 7 characterized in that said wedge has a length which is greater than a depth of said mounting hole.

9. The hand tool with firm connection according to claim 1 characterized in that in the grip, there is a longitudinal hole at the center of each arc.

10. The hand tool with firm connection according to claim 1 characterized in that there is a longitudinal plastic pin in the grip.

11. The hand tool with firm connection according to claim 1 characterized in that said mounting hole is the through hole and a wedge is fitted in said mounting hole, a counter bore being made at the another end of the head of hand tool opposite to the entry end for fitting, a sunk platform being made at the back-end of the wedge, and after fitting, the sunk platform is fitted into the counter bore.

12. The hand tool with firm connection according to claim 7 characterized in that there is an inner hole in the wedgelike part of said wedge.

13. The hand tool with firm connection according to claim 5 characterized in that there is a transverse through hole made at the fitting end of said grip, that there are pin slots made at both ends of the transverse through hole, and that there is a plastic pin fitted in the transverse through hole.

14. The hand tool with firm connection according to claim 2 characterized in that there is at least one longitudinal through hole being made on another end of the head of hand tool opposite to the entry end for fitting, the size of which is smaller than the underside of the blind hole and which communicates with the mounting hole.

15. The hand tool with firm connection according to claim 14 characterized in that the through hole on said another end is formed with a counter bore being made on this another end.

16. The hand tool with firm connection according to claim 14 or 15 characterized in that there is a nail installed in the through hole on said another end, and there is one segment of wedge on said nail.

17. The hand tool with firm connection according to claim 5 characterized in that there is a screw being made on a front-end of said nail, there is a sunk platform made on a back-end, the nail having a length which is greater than the total length of the head of hand tool and the grip after fitting, the nail extends through the head of hand tool and the grip, the screw of its front-end comes out of the back-end of the grip and is connected with a nut.

18. The hand tool with firm connection according to claim 1 characterized in that said mounting hole is formed with a counter bore made at the entry end for fitting.

19. The hand tool with firm connection according to claim 1 characterized in that there is adhesive between the fitting end of said grip and the mounting hole.

20. The hand tool with firm connection according to claim 1 characterized in that there is a protecting layer at the outer edge of said grip.

21. An ax or hammer with firm connection includes an ax or hammer head, a grip and a wedge; the grip having a fitting end, the ax or hammer head has a fitting hole, characterized in that said grip has a shape which is a straight barrel, the grip is hollow inside and has a hole; the fitting end of the grip having a cross section, the shape of which is formed by interconnecting several segments of arcs which have not the same center.

22. Tie ax or hammer with firm connection according to claim 21 characterized in that there is a reentrant being formed at the place where the arcs are interconnected, and there is a longitudinal flute formed at the outer surface of the fitting end.

23. The ax or hammer with firm connection according to claim 21 characterized in that the fitting hole is a through hole or blind hole, the fitting hole has a bottom which is wedgelike and has an end that has a shape which is straight barrel, and the end has a cross section, the shape of which is identical to the shape of the cross section of said fitting end.

24. The ax or hammer with firm connection according to claim 21 characterized in that there is one or more holes.

25. The ax or hammer with firm connection according to claim 21 characterized in that the hole is a through hole and the hole has a cylindrical shape.

26. The ax or hammer with firm connection according to claim 21 characterized in that the wedge has a top which is wedgelike, and has a bottom which is cylindrical shape.

27. The ax or hammer with firm connection according to claim 21 or 26 characterized in that said wedge has a length which is greater than that of said fitting hole.

28. The ax or hammer with firm connection according to claim 27 characterized in that the wedge and the hole are in interference fit.

29. The ax or hammer with firm connection according to claim 21 characterized in that there is adhesive between said fitting end and the fitting hole.

30. The ax or hammer with firm connection according to claim 21 characterized in that there is a protecting layer at the outer edge of said grip.
